(19) United States
(12) Patent Application Publication
(10) Pub. No.: US 2007/0151796 A1
(43) Pub. Date: Jul. 5, 2007

(54) Sound damping apparatus

(76) Inventor: Oliver Heid, Gunzenhausen (DE)

Correspondence Address: SCHIFF HARDIN, LLP;PATENT DEPARTMENT, 6600 SEARS TOWER, CHICAGO, IL, 60606-6473, US

(21) Appl. No.: 10/892,661

(22) Filed: Jul. 16, 2004

(30) Foreign Application Priority Data
Jul. 18, 2003 (DE) 103 32 833.5

(51) Int. Cl. F16F 15/00

(52) U.S. Cl. 181/207

(57) ABSTRACT

A sound damping apparatus includes a bearing element or base, a surface membrane which is connected to the base to form a gas volume and a spring element arrangement disposed between the bearing element and the surface membrane to hold the surface membrane at a distance from the bearing element to form a gas volume. An advantageous embodiment is that the gas volume is partially evacuated and the spring element arrangement comprises non-linear springs with a degressive characteristic line. The elastic effect of the spring element arrangement and the pressure in the gas volume create a large resilience of the surface membrane against pressure changes outside of the gas volume.

### BACKGROUND OF THE INVENTION

The present invention is concerned with a sound damping apparatus.

For noise damping, sound-absorbing materials, such as foam plastic, are used. The effect of the sound damping at low sound frequencies is admittedly, for the most part, low. A noise damping in a large frequency range of, for example, 50 Hz to 5 kHz is of great interest, especially in large medical devices, since the patients are exposed to noises of the large medical device at short range in the examination time span.

An article by T. Matzuk entitled “Improvement of Low-Frequency Response in Small Loudspeaker System by Means of the Stabilized Negative-Spring Principle”, The Journal of the Acoustical Society of America, Vol. 49, No. 5, 1971, pp. 1362-1366 specifies the use of stabilized passive negative springs to expand the low-frequency response of small loudspeaker systems. A negative spring is stabilized via a feedback system.

The buckling of rods is dealt with in chapter 7 entitled “Stabilitätsprobleme” of Dubbel, Taschenbuch für den Maschinenbau published by W. Beitz and K.-H. Küttner.

### SUMMARY OF THE INVENTION

The invention is based on the object of providing a compact apparatus for noise damping. The noise damping should preferably occur in the low-frequency range.

This object is inventively achieved via a sound damping apparatus that is formed of a bearing element or base and a surface membrane, which are connected with one another and spaced apart by spring elements that hold the surface membrane at a distance from the bearing element. The spaced apart bearing element and membrane mutually enclose a gas volume. The spring elements are fashioned so that they support the surface membrane and simultaneously form a type of frequency-independent “slack wall” via the surface membrane. If the surface membrane exhibits a large pressure elasticity, it thus forms a wall with a very low sound impedance, which prevents sound propagation through the wall.

In an advantageous embodiment, the gas volume exhibits a pressure that is smaller than the pressure predominant in the environment surrounding the sound damping apparatus. This has the advantage that the pressure elasticity of the surface membrane is increased in the direction of the bearing element, since the elastic force of the gas filling the gas volume is less, due to the reduced pressure.

In an advantageous development, the gas volume can be evacuated with means that can be preferably connected to either the bearing element or to the surface membrane. This has the advantage that the elastic effect of the gas volume on the spring elements can be adjusted via the evacuation of the gas volume.

In an evacuated gas volume, the spring elements additionally serve to support the surface membrane against the static pressure that the environment places on the surface membrane. The lower the pressure in the gas volume, the lower the acoustic impedance of the system from the surface membrane and gas volume.

In a particularly advantageous embodiment, the spring element comprises a spring with a degressive characteristic line. This means a degressive dependency of the force generated by the deflection of the spring on the deflection. Degressive characteristics are gradual decreases in stages or steps. By spring characteristic line, what is understood is a change of the elastic force dependent on the deflection. Springs with degressive characteristic line have a property that the spring characteristic line runs substantially flatter at the operating point that is, for example, given by the load with the static air pressure than in a conventional spring. Already, small pressure variations via sound radiation lead at the working point to a substantially larger deflection of the surface membrane than, for example, they occur given an air-filled air double wall or given a surface membrane cushioned with normal springs.

Springs with degressive characteristic line can, for example, be generated with special spiral or plate springs. A thin spiral spring rod, for example a curving or flexible rod, or a thin spring wall which has a dish shape, likewise, exhibit the special dependency of the elastic force on the deflection.

In a special embodiment, the bearing element and the surface membrane are fashioned in a type of pillow-like cell, of which, in particular, a plurality of cells are mutually used for sound damping.

Other advantages and features of the invention will be readily apparent from the following description, the claims and drawings.

### BRIEF DESCRIPTION OF THE DRAWINGS

FIG. 1 is a schematic cross-sectional view through a sound damping apparatus to explain the functionality of the design of the invention;

FIG. 2 is a schematic diagram of, for example, the spring characteristic lines occurring in FIG. 1;

FIG. 3 is a perspective view illustrating the pillow-like sound damping apparatus according to the present invention;

FIG. 4 is a perspective view of a sound damping apparatus according to FIG. 3 utilizing thin dish-shaped plates or walls as the spring elements; and

FIG. 5 is a perspective view of a magnetic resonant apparatus utilizing the sound damping apparatus of the present invention.

### DESCRIPTION OF THE PREFERRED EMBODIMENTS

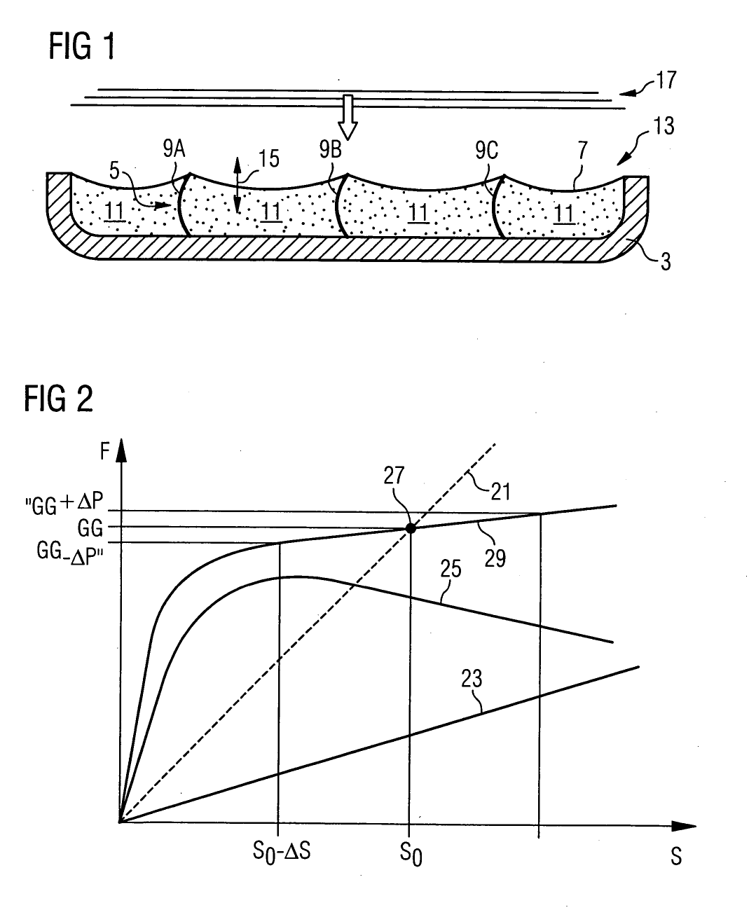

The principles of the present invention are particularly useful when incorporated in a sound damping apparatus illustrated in FIG. 1, which comprises a bearing element or base 3, a spring element arrangement 5 and a surface membrane 7. The spring element arrangement 5 comprises a plurality of spring rods 9A, 9B and 9C, which may be spiral spring rods or curved spring rods. The bearing element 3 and the surface membrane 7 enclose a gas volume 11, which is evacuated and, for example, exhibits a pressure of 1/10 of the surrounding air pressure in an environment 13 of the sound damping apparatus. The spring rods 9A-9C compensate for the pressure difference between the pressure in the gas volume 11 and the pressure of the environment 13 with their elastic force.

The spring rods exhibit a non-linear degressive characteristic line that is, for example, given by a theory from Euler's buckling load. Due to the special spring characteristic line, a small pressure change on the spring rods 9A-9C causes a large deflection of the spring rods in a deflection direction of the double arrow 15. The elastic effect of the gas volume is, for its part, reduced, due to the reduced pressure.

If a sound wave 17 impinges on the surface membrane 7, the pressure forces of the sound wave act on this membrane and, due to the non-linear resilience of the surface membrane 7, lead to a significant deflection of the surface membrane 7. This slack wall follows the movement of the air particles to subtend without resistance and, thus, to absorb sound energy. Due to the reduced pressure in the gas volume 11, no transmission or only a slight transmission of the noise to the bearing element 3 occurs.

The non-linear spring characteristic line of the curved spring rods is generated given an evacuation of the gas volume 11 by a buckling that can be described by Euler's theory for non-linear buckling of rods. With the residual pressure in the gas volume 11, the working point of the spring element 5 formed by the spring rods 9A-9C can be adjusted and, thus, the residual resilience of the surface membrane 7 is adjusted.

The sound damping apparatus leads to a sound damping in the frequency range of a few Hz to some kHz. The spring rods can, for example, be realized as fiberglass bristles. In an alternative construction, what is known as thin walls, meaning rods fashioned two-dimensionally, such as a curved dish-shaped element can be used as the spring element.

FIG. 2 schematically shows an overview of the various spring characteristic lines in connection with the sound damping apparatus of FIG. 1. A gas volume 11, which is filled with normal pressure and, therefore, has an air rigidity at normal pressure, has a spring characteristic which is shown as a dashed line or curve 21. A line 23 shows the elastic effect of the gas in the gas volume 11 with reduced pressure, for example 1/10 of the initial pressure or roughly 1/10 of an atmosphere which is less than 1 bar.

A spring characteristic line 25 shows a special, non-linear spring characteristic for the spring rods. After buckling, the spring rods exhibit a degressive curve, meaning a decrease in the elastic force F in the spring characteristic line 25.

At the equilibrium state GG, the elastic force F of the spring rods 9A-9C compensate the force of the surface membrane due to the pressure difference between the pressure of the environment 13 and the pressure in the gas volume 11. A total spring characteristic line 29 that, at the equilibrium state GG gives an equilibrium length SO of the spiral rods 9A-9C can correspondingly be associated with the sound damping apparatus. A slight pressure change ΔP leads to a new equilibrium force GG-ΔP, which gives a new length of the spiral spring rods 9A-9C with a value S0-ΔS, whereby ΔS is the deflection from the equilibrium length S0. Due to a very flat curve of the total spring characteristic line 29 through the working point 27, one obtains an especially high resilience in the surface membrane that leads to the desired sound damping.

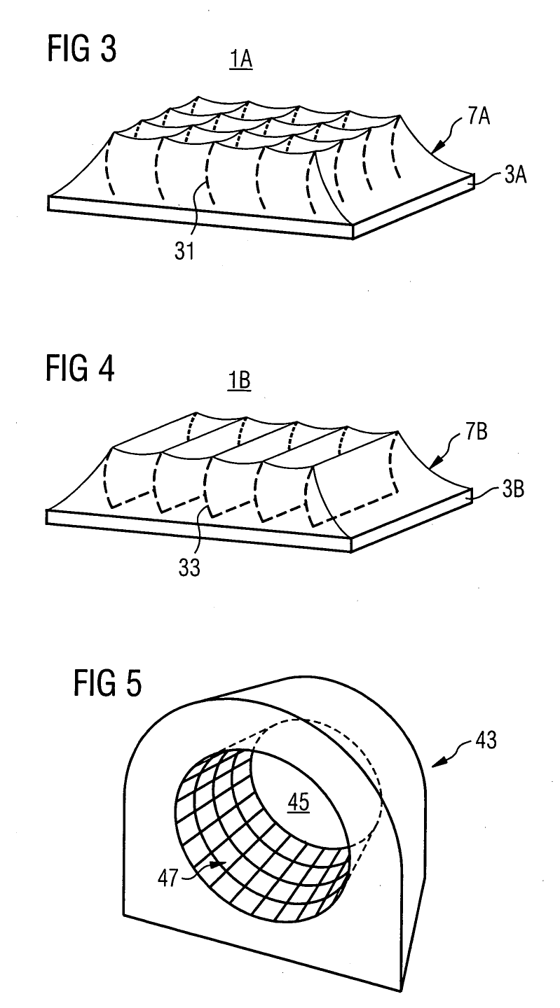

FIG. 3 schematically shows a design of a sound damping cell 1A, which is fashioned pillow-like with a bearing plate or base 3A that can, for example, be deformably attached to a curved surface. A surface membrane 7A is kept at a distance from the bearing plate 3A with the aid of spring rods 31, which may be fiberglass bristles.

In FIG. 4, a sound damping cell 1B is illustrated and has a pillow-like structure of the surface membrane 7B, which is connected to the bearing plate or base 3B and held in space relationship by spring elements 33, which have the shape of curved rectangular-shaped plates or dishes.

In FIG. 5, a magnetic resonance apparatus has a housing 43 that surrounds a noise source 45, for example the gradient coils. For optical reasons, the inside of the housing 43 is lined with a tile-like arrangement 47 of a plurality of sound damping apparatuses in accordance with the present invention.

Although various minor modifications may be suggested by those versed in the art, it should be understood that I wish to embody within the scope of the patent granted hereon all such modifications as reasonably and properly come within the scope of my contribution to the art.

I claim:

1. A sound damping apparatus comprising a bearing element, a surface membrane and a spring element arrangement, the surface membrane being connected to the bearing element with the spring element arrangement disposed therebetween to hold the surface membrane at a distance from the bearing element to form a gas volume.

2. A sound damping apparatus according to claim 1, wherein the distance of the surface membrane from the bearing element is determined by the elastic effect of the spring element arrangement and a gas pressure in the gas volume.

3. A sound damping apparatus according to claim 1, wherein the elastic effect of the spring element arrangement and the pressure in the gas volume is non-linear.

4. A sound damping apparatus according to claim 1, wherein the elastic effect causes a large resilience of the surface membrane against pressure changes outside of the gas volume.

5. A sound damping apparatus according to claim 1, wherein the pressure in the gas volume exhibits a pressure less than 1 bar.

6. A sound damping apparatus according to claim 1, wherein the gas volume is evacuated by means that can preferably be connected to one of the bearing element and the surface membrane, so that the pressure in the gas volume is less than the pressure in the surrounding atmosphere.

7. A sound damping apparatus according to claim 1, wherein the spring element arrangement comprises springs with a degressive characteristic line with a degressive dependency of the force effected by the deflection of the spring on the amount of deflection.

8. A sound damping apparatus according to claim 1, wherein the distance of the surface membrane from the bearing element is determined by the elastic effect of the spring element arrangement and the pressure in the gas volume and wherein the spring element exerts an elastic force to support the surface membrane when subjected to environmental pressures.

9. A sound damping apparatus according to claim 1, wherein the spring element arrangement comprises a plurality of spiral springs.

10. A sound damping apparatus according to claim 1, wherein the spring element arrangement comprises a plurality of thin spiral spring rods.

11. A sound damping apparatus according to claim 1, wherein the spring element arrangement comprises thin curved spring elements.

12. A sound damping apparatus according to claim 1, wherein the bearing element and the surface membrane are fashioned in pillow-like cells which have a plurality of cells acting for damping sound.
